(19) United States
(12) Patent Application Publication
(10) Pub. No.: US 2013/0134699 A1
(43) Pub. Date: May 30, 2013

(54) HOSE CONNECTION ARRANGEMENT

(71) Applicants: Helen Esders, Lohne (DE); Heiko Bock, Abstatt (DE)

(72) Inventors: Helen Esders, Lohne (DE); Heiko Bock, Abstatt (DE)

(21) Appl. No.: 13/201,103

(22) PCT Filed: Jan. 27, 2010
(86) PCT No.: PCT/EP2010/050928

§ 371 Date: Dec. 8, 2011

(30) Foreign Application Priority Data
Feb. 11, 2009 (DE) 102009008394.4

(51) Int. Cl. F16L 31/00; F16L 37/098

(52) U.S. Cl. CPC F16L 31/00; F16L 37/098
USPC 285/3

(57) ABSTRACT

A hose connection arrangement for inseparably connecting media-conducting hoses in particular, having a first connection element and a second connection element. The first connection element has an annular lug that surrounds an annular end region. A sealing element is arranged therebetween. For inseparable connection of the two connection elements, said elements have at least one latching element pair. The two latching elements latch into one another by plugging the two connection elements together.

### BACKGROUND

1. Field of the Disclosure

The disclosure relates to a hose connection arrangement for establishing an inseparable connection of hoses, in particular media-conducting hoses. The hose connection arrangement is particularly useful for the connecting of hoses in automobiles.

2. Discussion of the Background Art

Especially for safety reasons, it is necessary or even legally prescribed that media-conducting hoses in automobiles are inseparably connected to each other. The term “inseparably” in this context is to be understood in the sense that a separation of the connection is possible only by destroying the connection element. Such a hose connection arrangement is known from DE 101 07 465. This arrangement is of a three-part type. One of the two connection elements comprises two parts, a first part among them being attached to the hose or tube e.g. by bonding. Connected to this part is a substantially cylindrical hood. This can be realized e.g. by a force-locked connection with the aid of a snap ring, or by producing the hood from a piece of sheet metal to be connected to said first part by flanging. By said first part and the hood, there is formed an annular gap into which the other connection element of the connection arrangement will be introduced. The other connection element herein comprises a substantially cylindrical projection which will be inserted into the annular recess. Between the two component parts, an O-ring is provided for sealing. For tight connection of the plugged-in connection element to the hood, the hood comprises a plurality of radial slots or openings via which spring elements can be inserted through the hood or casing from outside. Said spring elements engage an annular groove provided on the circumference of the plugged-in connection element. The hose connection arrangement described in DE 101 07 465 for the inseparable connecting of media-conducting hoses in automobiles is complicated under the aspects of construction and mounting alike. Particularly, it is required that the hood or casing is made of a deformable sheet metal piece so that, by flanging, attachment to the other part of the corresponding connection element is made possible. Flanging constitutes an additional working step which is bothersome.

It is an object of the disclosure to provide a hose connection arrangement for establishing an inseparable connection of hoses, in particular media-conducting hoses, by means of which an inseparable connection can be realized in a simple manner.

### SUMMARY

The hose connection arrangement of the disclosure comprises a first as well as a second connection element. Said first connection element comprises an annular lug, and said second connection element comprises an annular end region, said annular lug surrounding said annular end region. Between the annular lug of the first connection element and the annular end region of the second connection element, a sealing element such as, e.g., an O-ring is arranged. Particularly, said O-ring surrounds the annular end region and is preferably located in a groove provided on the outer circumference of the annular end region. In this regard, it is particularly preferred that said groove will be generated only after the two connection elements have been plugged together. This has the advantage that the two connection elements are demoldable more easily because no undercuts need be provided for the groove.

According to the disclosure, at least one latching element is provided on each of the two connection elements. Thus, the connection elements are provided with a pair of latching elements, wherein the pair of latching elements is configured to the effect that, by plugging together the connection elements, the latching elements will lockingly engage each other and establish an inseparable connection. The connection is inseparable in the sense that the two connection elements cannot be detached from each other without being destroyed. The provision of at least one pair of latching elements has the advantage that the two connection elements will be connected to each other by simply being plugged together. A provision of additional holding elements, such as e.g. spring elements, pins, screws or the like, is not required. Since the undetachable connection is effected by simply plugging together the two connection elements of the hose connection arrangement, the expenditure for mounting is considerably reduced.

Preferably, a first latching element which is attached to one of the two connection elements is provided with at least one latching lug. In the assembled state, said latching lug engages behind the second latching element which is formed e.g. as a web or projection. According to a particularly preferred embodiment, the latching lug is configured in such a manner that, during assembly of the connection elements, the latching lug itself and/or the other connection element cooperating with the latching lug will be released from its rest position, preferably by elastic deformation and, as soon as the connection elements have been fully plugged together, will snap back into its rest position so that the latching lug will engage behind the other latching element. Thus, the latching lug of the first latching element will be in engagement behind the second latching element in the longitudinal direction of the two connection elements. In this regard, it is particularly preferred that the first latching element comprises two mutually opposite latching lugs which, particularly, engage behind the same second latching element. Herein, it is preferred that, during the mounting process, i.e. when plugging the two connection element into each other, the two latching lugs will be urged away from each other or apart from each other and, as soon as the two connection elements have been fully plugged together, will snap back into their original positions and thus will engage behind the second latching element.

In order to keep the production of the two connection elements as simple and inexpensive as possible, it is particularly preferred that said at least one first and said at least one second latching element are formed integrally with the first and respectively the second connection element. Herein, it is particularly preferred that these elements are made of plastic, with the two connection elements preferably being injection-molded plastic components. Due to the one-pieced design of the first and preferably also the second connection element, the manufacturing costs can be considerably reduced. Connection of component parts by flanging, attachment of snap rings and the like, as described in DE 101 07 465, is preferably not required.

It is particularly preferred that a plurality of pairs of latching elements are provided, preferably being distributed on the circumference in a uniform manner. Thereby, a safe connection is guaranteed also, e.g., in case that a bending deflection of the hose occurs in the region of the hose connection arrangement.

According to a particularly preferred embodiment, the second latching elements are arranged in a pocket of the connection element. Thus, for connection to the second latching elements, the first latching elements will be introduced into a respective pocket. In such an arrangement, the at least one second latching element can be e.g. a lateral recess in the pocket, provided for to be engaged by hook-shaped first latching elements. According to a preferred embodiment, which particularly is more easily produced under the technical aspect, the second latching elements are formed as webs arranged in said pocket. Herein, the webs can have a rectangular or trapezoidal cross section. It is particularly preferred that the pocket has an annular shape so that the—preferably plural—second latching elements are arranged in common pocket and are preferably formed as webs. In this arrangement, the pocket is preferably open in the longitudinal direction, thus generating a circular opening facing toward the other connection element. The preferably web-shaped second latching elements are arranged radially and with preference are connected to two mutually opposite side walls of the pocket while preferably being integrally formed with these.

In a preferably circular pocket, the first latching elements, i.e. particularly the pairs of latching lugs, are formed in annular lug. For connecting the two connection elements, this annular lug will be inserted into the annular pocket in the longitudinal direction of the connection elements. In the process, the—preferably plural—pairs of latching elements will lockingly engage the corresponding second, preferably web-shaped latching elements, wherein respectively one pair of latching elements will engage behind a second latching element to realize an inseparable connection.

For forming said pairs of latching elements, the annular projection which will be inserted into the annular pocket is provided with a recess shaped in the manner of the tip of an arrow. Said recess comprises an opening oriented in the longitudinal direction. In the assembly process, the web-shaped second latching element will pass through this opening into the recess which follows the opening in the axial direction. Thereby, the latching lugs will be urged to the side and will snap back into the original position as soon as the second latching elements enter the recess, i.e. when the two connection elements have been fully plugged together.

According to a particularly preferred embodiment, at least one optical window is provided. The optical window is arranged to allow for visual inspection of one of the pairs of latching elements. This makes it possible to verify the correctness of assembly in a simple manner. Preferably, the corresponding optical window is provided in the outer wall forming said annular pocket. The optical window is preferably arranged adjacent to the at least one second latching element so that, in the assembled state, the first latching element, preferably the pair of latching lugs, will be visible through the optical window. The optical window is arranged in such a manner that, as soon as the first latching element is visible, the two latching elements have been inseparably locked to each other. Preferably, one optical window is provided per pair of latching elements.

To facilitate the assembly of the two connection elements, it is further preferred that the annular end region of the second latching element and/or the annular lug of the first connection element are provided with an introduction slope. With the aid of said at least one introduction slope, the two connection elements will be automatically centered relative to each other.

The disclosure will be explained in greater detail hereunder with reference to the accompanying drawings.

### BRIEF DESCRIPTION OF THE DRAWINGS

In the drawings:

FIG. 1 is a schematic lateral view of a preferred embodiment of the hose connection arrangement in the non-assembled state,

FIG. 2 is a view of the hose connection arrangement depicted in FIG. 1 in the assembled state, and

FIG. 3 is a schematic longitudinal sectional view of the hose connection arrangement depicted in FIG. 2.

### DETAILED DESCRIPTION OF THE PREFERRED EMBODIMENT

The preferred embodiment of the hose connection arrangement according to the disclosure, as illustrated in the Figures, comprises a first connection element 10 and a second connection element 12. The two connection elements 10,12 are each formed in one piece and are preferably produced by injection molding. According to a preferred embodiment, said connection elements are plastic parts. The two connection elements 10,12 can be fastened to hoses by way of known connection techniques, such as e.g. bonding. It can also be provided that the connection elements are realized directly as end portions of hoses or plastic tubes and thus are formed integrally with a plastic hose or plastic tube.

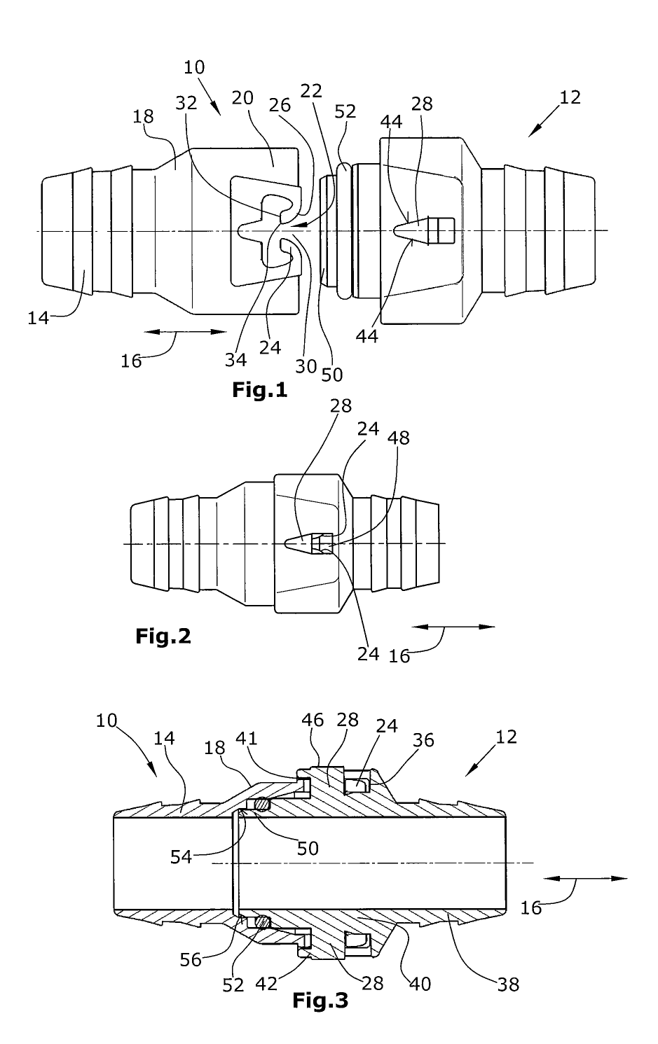

The first connection element 10 comprises a tube portion 14 which optionally is formed integrally with a hose or tube. Via an intermediate member 18 conically widened toward the outside, said tube portion 14 is connected in the longitudinal direction 16 to a substantially cylindrical annular projection 20. Within said annular projection 20, the first latching element 22 is provided, wherein a plurality of such first latching elements 22—two in the illustrated embodiment—are provided. Each first latching element 22 comprises two mutually opposite latching lugs 24. The two latching lugs 24 are configured to present two edge portions 26 extending toward each other in the longitudinal direction 16, i.e. toward the left-hand side in FIG. 1. Thus, the first latching element 22 comprises an opening 30 facing in the direction of a second latching element 28. Said opening 30, being of a tapered shape due to said two edge portions 26, then merges into a holding opening 32. Said two openings 30,32 are connecting to each other via a small passage opening 34, thus forming an arrow-shaped opening 30,34,32 in plan view.

In correspondence to first latching element 22, the second connection element 12 is respectively provided with the second latching element 28. The second latching elements 28—in the illustrated embodiment, being provided in a number of two—are arranged at a mutual offset of 180° (FIG. 3). The two latching elements 28 are arranged within a common annular pocket 36. This pocket 36 completely surrounds a tube portion 38 of second connection element 12. Pocket 36 comprises an annular opening 41 facing in the longitudinal direction. Into this annular opening 41, the annular projection 20 of first connection element 10 will be introduced for assembly. The two latching elements 28 are formed integrally with the second connection element. They are designed as webs which relative to the longitudinal direction 16 extend radially and which are arranged between an inner wall 40 and an outer wall 42, i.e. between mutually opposite side walls 40,42 of pocket 36.

Upon insertion of the annular projection 20 of the first connection element 10 for assembly of the two connection elements 10,12, the mutually opposite latching lugs 24 will be pressed apart and respectively elastically deformed by the second latching elements 28. This is feasible in a simple manner with the aid of the inclined edge portions 26 and of corresponding inclinations 44 preferably provided on the second latching element. As soon as the two connection elements 10,12 have been entirely plugged into each other, the latching lugs 24 will snap back again into the original position (FIG. 1), thus engaging behind the second latching elements 28 in the longitudinal direction 16.

For forming the pocket 36, there is thus provided a circular-cylindrical, hood-shaped projection 46 preferably formed integrally with the second connection element 12, said projection forming one of the two side walls 40. Within projection 46, preferably one optical window 48 is formed per pair of latching elements 22,28. Said optical window 48 is arranged in such a manner that, in the assembled condition (FIG. 2), the latching lugs 24 are partly visible. In this manner, it can be easily checked whether the latching lugs 24 have attained their locking position. Thereby, it is safeguarded that the latching lugs 24, as can be seen also in FIG. 3, engage behind the second latching elements 28 in the longitudinal direction.

Between said intermediate member 18 and a substantially cylindrical, annular end region 50 of second connection element 12, a sealing element is arranged in the form of an O-ring 52 surrounding said annular end region 50. Said O-ring is disposed in partial grooves formed by the mutually opposite elements 18,50 and is fixed in the corresponding position.

In the illustrated embodiment, for still further facilitating the assembly of the two connection elements 10,12, an introduction slope 54,56 is provided on the inner side of intermediate member 18 and on the outer side of annular end region 50.

What is claimed is:

1. A hose connection arrangement for inseparably connecting hoses, in particular media-conducting hoses, comprising
a first connection element having an annular lug,
a second connection element having an annular end region,
said annular lug surrounding said annular end region, with a sealing element being arranged therebetween, and
at least one pair of latching elements provided at said connection elements, said latching elements inseparably locking into one another by plugging the connection elements together.

2. The hose connection arrangement according to claim 1, wherein that at least one first latching element, which is attached to one of the two connection elements, comprises at least one and preferably two mutually opposite latching lugs adapted to engage, in the assembled state, behind the at least one second latching element attached to the other connection element.

3. The hose connection arrangement according to claim 1, wherein said at least one first latching element and/or said at least one second latching element are integrally formed with the first and respectively the second connection element.

4. The hose connection arrangement according to claim 2, wherein said at least one second latching element is formed within a preferably annular pocket and is preferably web-shaped.

5. The hose connection arrangement according to claim 2, wherein said at least one second latching element is connected to mutually opposite side walls of said pocket and preferably extends in radial direction with respect to a longitudinal axis of the corresponding connection element.

6. The hose connection arrangement according to claim 1, wherein a plurality of pairs of latching elements are provided, which preferably are arranged in a uniform manner on the circumference of the connection elements.

7. The hose connection arrangement according to claim 2, wherein said latching lugs, particularly a plurality of pairs of latching lugs, are formed by an opening or a respective opening in said annular lug.

8. The hose connection arrangement according to claim 7, wherein, in the assembly process, said opening is open toward the second latching element.

9. The hose connection arrangement according to claim 7, wherein, in the assembled state, said annular lug extends into said annular pocket along the entire circumference.

10. The hose connection arrangement according to claim 1, characterized by an optical window for verifying correct mounting of at least one and preferably of all pairs of latching elements.

11. The hose connection arrangement according to claim 1, wherein said annular end region and/or said annular lug comprise an introduction slope.
